(19) United States
(12) Patent Application Publication
(10) Pub. No.: US 2017/0354571 A1
(43) Pub. Date: Dec. 14, 2017

(54) DUAL VIAL ADAPTER ASSEMBLAGES WITH QUICK RELEASE DRUG VIAL ADAPTER FOR ENSURING CORRECT USAGE

(71) Applicant: MEDIMOP Medical Projects Ltd., Ra'anana (IL)

(72) Inventors: Uri DAVID, Nes Ziona (IL); Mordechai BUKHMAN, Netanya (IL)

(73) Assignee: MEDIMOP Medical Projects Ltd., Ra'anana (IL)

(21) Appl. No.: 15/541,242

(22) PCT Filed: Jan. 3, 2016
(86) PCT No.: PCT/IL2016/050002

§ 371 Date: Jun. 30, 2017

(30) Foreign Application Priority Data
Jan. 5, 2015 (IL) 236586

(51) Int. Cl. A61J 1/20

(52) U.S. Cl. CPC A61J 1/2089; A61J 1/2055; A61J 1/2013

(57) ABSTRACT

Dual vial adapter assemblages similar to U.S. Pat. No. 6,558,365 to Zinger et al. and U.S. Pat. No. 8,752,598 to Denenburg et al. and including a quick release drug vial adapter with an upright finger grip extension pair oppositely for manually urging inwards towards one another for releasing same from a drug vial. The quick release drug vial adapter ensures correct usage of a dual vial adapter assemblage by preventing immediate removal of a drug vial adapter from a drug vial after forming a liquid drug therein thereby assisting a healthcare provider to follow an administration protocol requiring an initial aspiration of some liquid drug for immediate administration purposes to a patient prior to subsequent infusion of the liquid drug remainder.

### CROSS-REFERENCE TO RELATED APPLICATIONS

This application is a Section 371 of International Application No. PCT/IL2016/050002, filed Jan. 3, 2016, which was published in the English language on Jul. 14, 2016, under International Publication No. WO 2016/110838 A1 and the disclosure of which is incorporated herein by reference.

### BACKGROUND OF THE INVENTION

The invention relates to dual vial adapter assemblages for use with a drug vial containing a medicament and a liquid vial containing liquid contents for forming a liquid drug from the medicament in the drug vial.

Commonly owned U.S. Pat. No. 6,558,365 to Zinger et al. entitled Fluid Transfer Device discloses a dual vial adapter assemblage hereinafter referred to as the Zinger assemblage for use with a drug vial containing a medicament and a liquid vial containing liquid contents for forming a liquid drug from the medicament in the drug vial. The liquid contents can be diluent only or include an active component. The Zinger assemblage is commercially available from West Pharmaceutical Services, Inc., Exton, USA under the registered trademark MIX2VIAL. The Zinger assemblage includes a drug vial adapter for telescopic mounting on a drug vial and a liquid vial adapter for telescopic mounting on a liquid vial. The drug vial adapter has an integral drug vial stopper puncturing cannula for puncturing a drug vial stopper and a female connector in flow communication therewith. The liquid vial adapter has an integral liquid vial stopper puncturing cannula and a male connector in flow communication therewith. The female connector is preferably a Luer female connector and the male connector is preferably a Luer lock connector for an initial sealed releasable inter-engagement on the Luer female connector.

The Zinger assemblage is designed to be employed for use with a drug vial under negative pressure for drawing liquid contents from a liquid vial in an initial sealed inter-engagement of the drug vial adapter and the liquid vial adapter. Accordingly, the Zinger assemblage is necessarily initially telescopically mounted on a liquid vial and on inversion subsequently telescopically mounted on a negative pressure drug vial. Pursuant to forming a liquid drug in the drug vial and detachment of the liquid vial adapter from the drug vial adapter, the entire liquid drug contents are typically completely aspirated into an initially empty needleless syringe for administration purposes.

Commonly owned U.S. Pat. No. 8,752,598 to Denenburg et al. entitled Liquid Drug Transfer Assembly discloses a dual vial adapter assemblage hereinafter referred to as the Denenburg assemblage. The Denenburg assemblage is similar in construction and operation as the Zinger assemblage but is designed to be used for larger liquid drug volumes. U.S. Pat. No. 8,752,598 FIGS. 7 to 9 show the Denenburg assemblage includes a liquid vial adapter with an integral dual lumen dual ended spike having a liquid vial stopper puncturing cannula and a drug vial stopper puncturing cannula oppositely directed to its liquid vial stopper puncturing cannula and a drug vial stopper puncturing cannula oppositely directed to its liquid vial stopper puncturing cannula. Also, the drug vial adapter includes a female connector and an oppositely directed drug vial adapter sleeve in flow communication therewith. The Denenburg assemblage employs gravitational flow from a liquid vial to a drug vial and therefore requires an initial telescopic mounting on a drug vial and a subsequent telescopic mounting on a liquid vial to avoid spillage from the liquid vial. U.S. Pat. No. 8,752,598 FIGS. 10A to 10G show the use of the Denenburg assemblage for forming liquid drug contents sufficient for aspiration of several liquid drug dosages for staggered administration to a patient.

Both the Zinger assemblage and particularly the Denenburg assemblage because of its intended use for forming larger liquid drug volumes can be optionally employed for an administration protocol to a patient including: First, initial aspiration of some liquid drug contents from a drug vial to an initially empty needleless syringe for immediate administration to a patient, thereby leaving a liquid drug remainder in the drug vial. And second, subsequent administration of the liquid drug remainder by removal of the drug vial adapter from the drug vial to expose its drug vial stopper and forced insertion of an infusion set's IV spike through the drug vial stopper for prolonged gravitational infusion flow to the patient. However, detachment of a drug vial adapter from a drug vial is dexterously difficult particularly in the case a drug vial adapter is telescopically snap fit mounted on a drug vial and a healthcare provider typically has gloved hands. Moreover, a healthcare giver may inadvertently detach a liquid vial adapter from a drug vial adapter before initial aspiration of some liquid drug contents in contradistinction to the administration protocol.

### BRIEF SUMMARY OF THE INVENTION

The present invention is directed towards dual vial adapter assemblages similar to hitherto described Zinger assemblage and Denenburg assemblage, and provides a dual vial adaptor assemblage as defined in claim 1. The dual vial adapter assemblages include a quick release drug vial adapter with a snap fit flex member pair for telescopic snap fit mounting on a drug vial and an upright finger grip extension pair oppositely extending to their snap fit flex member pair for manually urging inwards towards one another for outwardly flexing their snap fit flex member pair for releasing the quick release drug vial adapter from a drug vial. The inward flexing of the upright finger grip extension pair is precluded in an initial sealed inter-engagement of a liquid vial adapter and a quick release drug vial adapter such that a healthcare provider is unable to detach a drug vial adapter from the drug vial it is telescopically snap fit mounted thereon until detachment of the liquid vial adapter. Accordingly, the quick release drug vial adapter ensures correct usage of a dual vial adapter assemblage by preventing immediate removal of a drug vial adapter from a drug vial after forming liquid drug contents therein, thereby assisting a healthcare provider to follow an administration protocol requiring an initial aspiration of some liquid drug for immediate administration to a patient to leave a liquid drug remainder for subsequent infusion to the patient.

Dual vial adapter assemblages of the present invention can be implemented as follows: First, similar to hitherto mentioned U.S. Pat. No. 8,752,598 to Denenburg et al. Second, similar to U.S. Pat. No. 6,558,365 to Zinger et al. And third, similar to U.S. Pat. No. 6,558,365 to Zinger et al. but with a drug vial adapter having an integral dual lumen drug vial stopper puncturing cannula and a liquid vial adapter having an integral dual lumen liquid vial stopper puncturing cannula in initial flow communication with the integral dual lumen drug vial stopper puncturing cannula for enabling initial gravitational flow of liquid contents from a liquid vial to a drug vial.

### BRIEF DESCRIPTION OF THE SEVERAL VIEWS OF THE DRAWINGS

In order to understand the invention and to see how it can be carried out in practice, preferred embodiments will now be described, by way of non-limiting examples only, with reference to the accompanying drawings in which similar parts are likewise numbered, and in which:

In the drawings:

FIG. 1 is a pictorial view of an administration set including a needleless syringe, a drug vial, a liquid vial, an infusion set and a first embodiment of a dual vial adapter assemblage in accordance with the present invention;

FIG. 2 is a perspective view of the FIG. 1 dual vial adapter assemblage including a quick release drug vial adapter;

FIG. 3 is a perspective view of a dissembled FIG. 1 dual vial adapter assemblage;

FIG. 4 is a longitudinal cross section of the FIG. 1 dual vial adapter assemblage along line 4-4 in FIG. 2;

FIG. 5 is a perspective view showing manual operation of the FIG. 2 quick release drug vial adapter;

FIGS. 6A to 6C show use of the FIG. 1 dual vial adapter assemblage for administration of a liquid drug contained in a drug vial;

FIG. 7 is a perspective view of a second embodiment of a dual vial adapter assemblage including a quick release drug vial adapter in accordance with the present invention;

FIG. 8 is a longitudinal cross section of the FIG. 7 dual vial adapter assemblage along line 8-8 in FIG. 7;

FIG. 9 is a dissembled view of the FIG. 7 dual vial adapter assemblage;

FIG. 10 is a perspective view of a third embodiment of a dual vial adapter assemblage including a quick release drug vial adapter in accordance with the present invention;

FIG. 11 is a longitudinal cross section of the FIG. 10 dual vial adapter assemblage along line 11-11 in FIG. 10; and

FIG. 12 is a dissembled view of the FIG. 10 dual vial adapter assemblage.

### DETAILED DESCRIPTION OF THE INVENTION

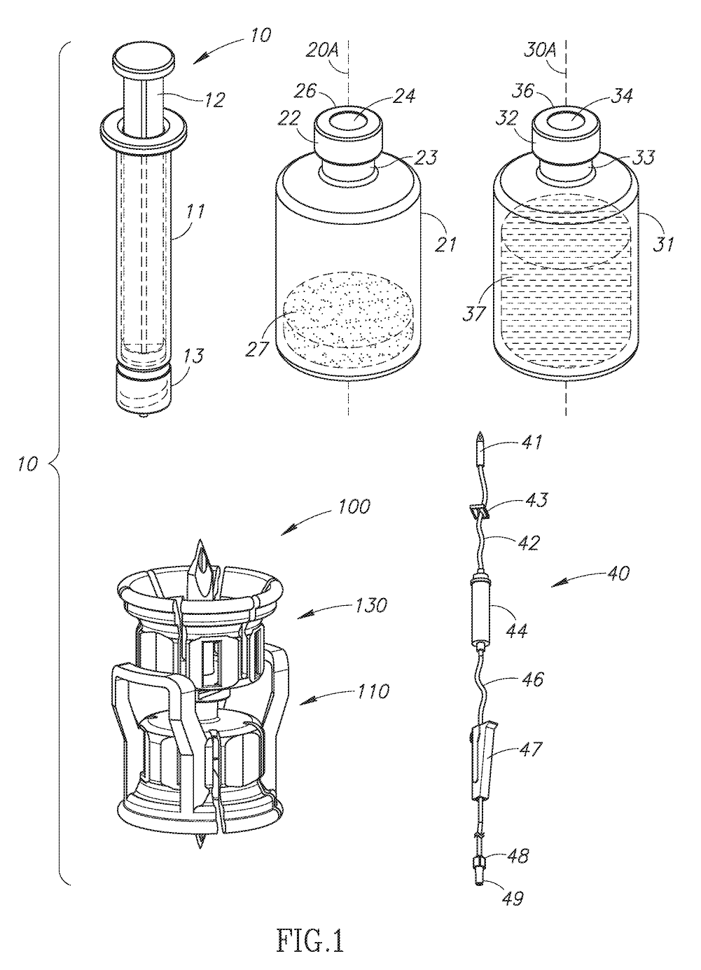

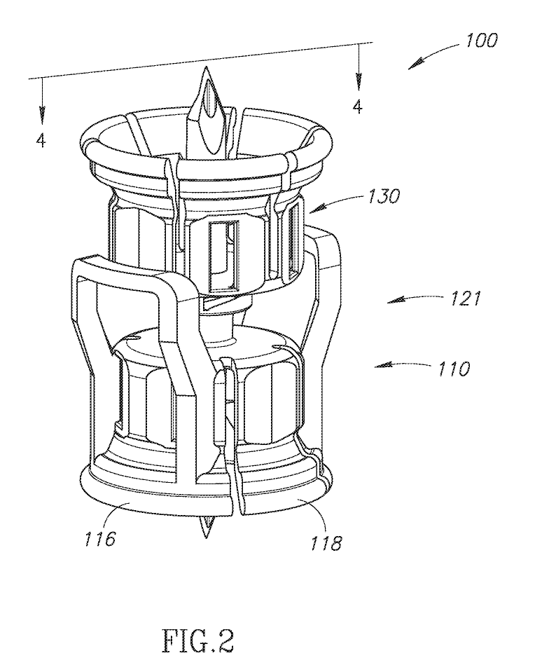

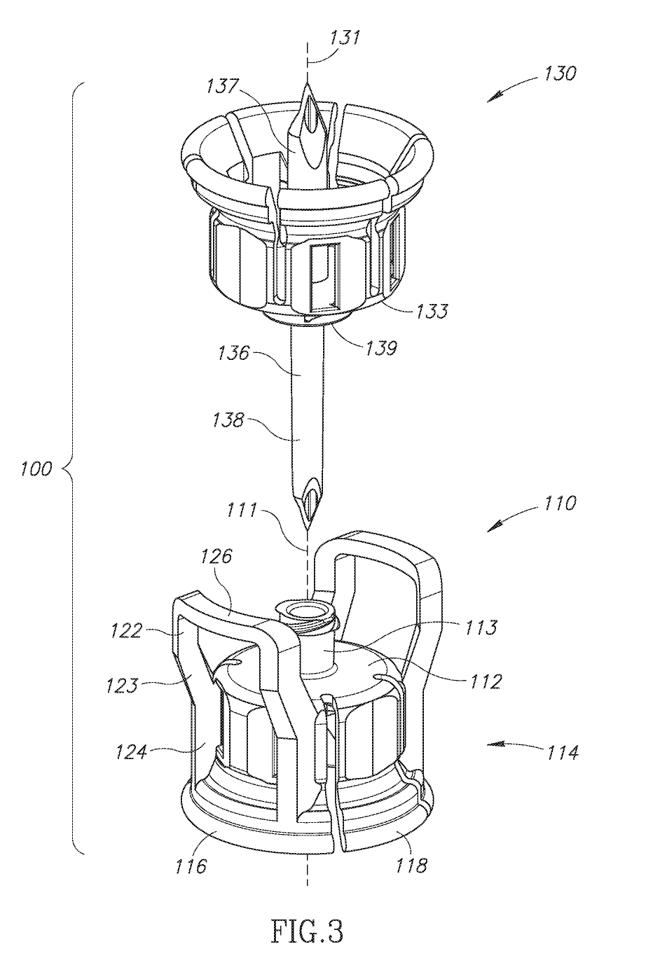

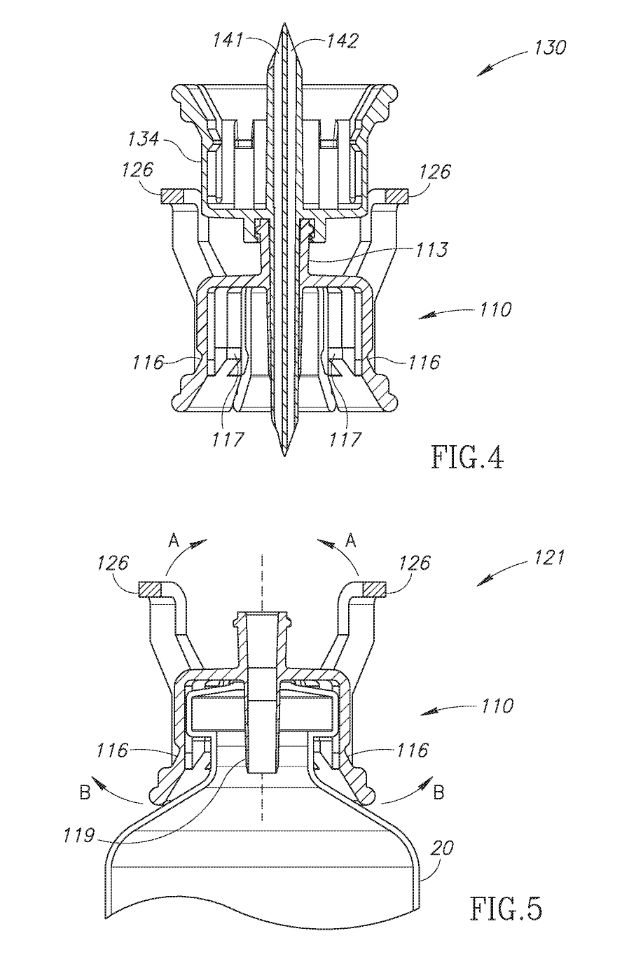

FIG. 1 shows an administration set 10 including an initially empty needleless syringe 10, a drug vial 20, a liquid vial 30, and an infusion set 40, and a dual vial adapter assemblage 100. The needleless syringe 10 includes a barrel 11 with a plunger 12 and a male Luer lock connector 13. The syringe 10 can be formed with other types of male connectors. The drug vial 20 has a longitudinal drug vial axis 20A and includes an open topped drug vial bottle 21 having a drug vial rim 22 and a narrow diameter drug vial neck 23. The drug vial 20 is sealed by a drug vial stopper 24. The drug vial stopper 24 is capped by a typically aluminum seal 26. The drug vial 20 includes a medicament 27 in the form of a powder, solid or liquid. The liquid vial 30 has a longitudinal liquid vial axis 30A and includes an open topped liquid vial bottle 31 having a liquid vial rim 32 and a narrow diameter liquid vial neck 33. The drug vial 30 is sealed by a liquid vial stopper 34. The liquid vial stopper 34 is capped by a typically aluminum seal 36. The liquid vial 30 includes liquid contents 37 in the form of diluent only or an active component. The infusion set 40 includes an IV spike 41, first tubing 42, a clamp 43, a drip chamber 44, second tubing 46, a roller clamp 47, a male Luer connector 48, and a Luer shield 49.

The dual vial adapter assemblage 100 includes a quick release drug vial adapter 110 and a liquid vial adapter 130 in initial sealed releasable inter-engagement. The drug vial adapter 110 has a longitudinal drug vial adapter centerline 111 and a transverse drug vial adapter top wall 112 with an upright female connector 113 and an opposite downward depending drug vial adapter skirt 114 for telescopic snap fit mounting on the drug vial 20. The upright female connector 113 can be a female Luer connector, and the like. The downward depending drug vial adapter skirt 114 includes an opposite snap fit flex member pair 116 resiliently pivotal at their juncture with the drug vial adapter top wall 112. The snap fit flex member pair 116 is formed with an inward directed protrusion pair 117 for snap fit under the drug vial rim 22 on telescopic snap fit mounting the drug vial adapter 110 on the drug vial 20. The downward depending drug vial adapter skirt 114 includes an additional opposite flex member pair 118 primarily employed for guidance purposes during the telescopic snap fit mounting and therefore formed with minor or without any inward directed protrusions.

The drug vial adapter 110 has a downward depending sleeve 119 in flow communication with the upright female connector 113 and oppositely directed thereto. The drug vial adapter 110 has a manually operable quick release arrangement 121 for selectively releasing the drug vial adapter skirt 114 from the drug vial 20, thereby exposing the drug vial stopper 24.

The liquid vial adapter 130 has a longitudinal liquid vial adapter centerline 131 co-axial with the longitudinal drug vial adapter centerline 111 on its initial sealed releasable inter-engagement with the drug vial adapter 110. The liquid vial adapter 130 includes a transverse liquid vial adapter top wall 133 and a liquid vial adapter skirt 134 for telescopic snap fit mounting on the liquid vial 30. The liquid vial adapter skirt 134 can optionally telescopically mount on the liquid vial 30 without snap fit.

The liquid vial adapter 130 includes a dual ended dual lumen spike 136 including a liquid vial stopper puncturing cannula 137 for puncturing the liquid vial stopper 34 on telescopic snap mounting the liquid vial adapter 130 on the liquid vial 30 and a drug vial stopper puncturing cannula 138 oppositely directed to the liquid vial stopper puncturing cannula 137 along the longitudinal liquid vial adapter centerline 131 for puncturing the drug vial stopper 24 on mounting the drug vial adapter 110 on the drug vial 20 in the assembled state of the dual vial adapter assemblage 100. The drug vial stopper puncturing cannula 138 is encircled by the downward depending sleeve 119 in the initial sealed releasable inter-engagement of the drug vial adapter 110 and the liquid vial adapter 130. The liquid vial adapter 130 includes a male lock connector 139 for releasable engaging the female connector 113. The male lock connector 139 is preferably a male Luer lock. The dual ended dual lumen spike 136 includes a liquid transfer lumen 141 and an air transfer lumen 142.

The quick release arrangement 121 is constituted by a pair of opposite upright finger grip extensions 122 oppositely extending to the snap fit flex member pair 116 relative to the drug vial adapter top surface 112. The finger grip extensions 122 are in the form of an inverted U-shape frame 123 each including a pair of opposite upright leg members 124 and a cross member 126 extending therebetween. The U-shape frame 123 reduces the manual force required to be applied to inwardly urge the finger grip extensions 122 toward one another. In the disassembled state of the dual vial adapter assemblage 100, manual inward urging of the finger grip extensions 122 towards one another as denoted by arrow A pivots the snap fit flex member pair 116 at their juncture with the drug vial adapter top surface 112 to outwardly urge their inward directed protrusion pair 117 away from the longitudinal drug vial adapter centerline 111 as denoted by arrows B. Such outward urging is sufficient that at most only a minor force is required to release the drug vial 20 from the drug vial adapter skirt 114. Preferably the outward urging is sufficient to release the drug vial 20 from the drug vial adapter skirt 114. In the assembled state of the dual vial adapter assemblage 100, the cross members 126 face the liquid vial adapter skirt 134 and are sufficiently close thereto such that the liquid vial adapter skirt 134 prevents manual inward urging of the finger grip extensions 122 toward one another to pivot the snap fit flex member pair 116.

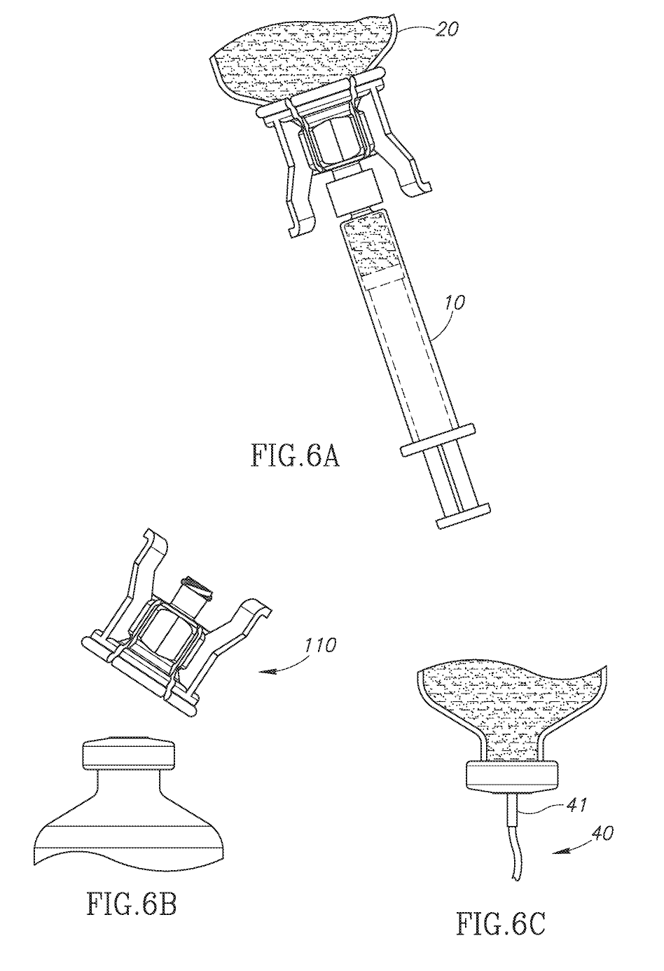

The use of the dual vial adapter assemblage 100 is the same as the aforementioned U.S. Pat. No. 8,752,598 FIGS. 10A to 10G for preparing liquid drug contents in the drug vial 20, detaching the liquid vial adapter 130 from the drug vial adapter 110 and attaching the needleless syringe 10 for aspirating some liquid drug for administration purposes to leave a liquid drug remainder in the drug vial (see FIG. 6A). Use of the dual vial adapter assemblage 100 additionally includes the step of manual operation of the quick release arrangement 121 to facilitate detaching the drug vial adapter 110 from the drug vial 20 to expose its drug vial stopper 24 (see FIG. 6B) and insertion of an infusion set's IV spike 41 through the drug vial stopper 24 for gravitational infusion of the liquid drug remainder to a patient (see FIG. 6C).

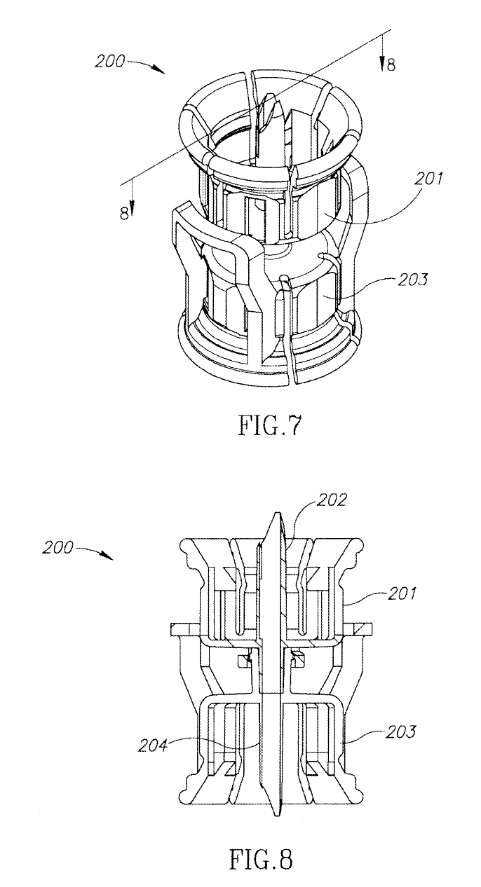

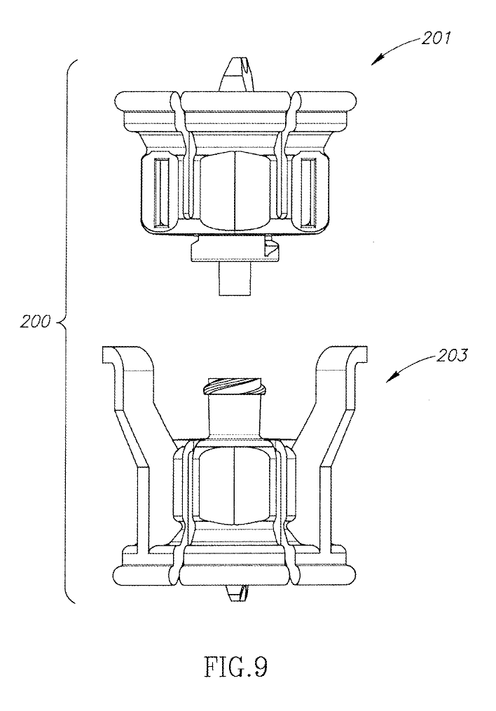

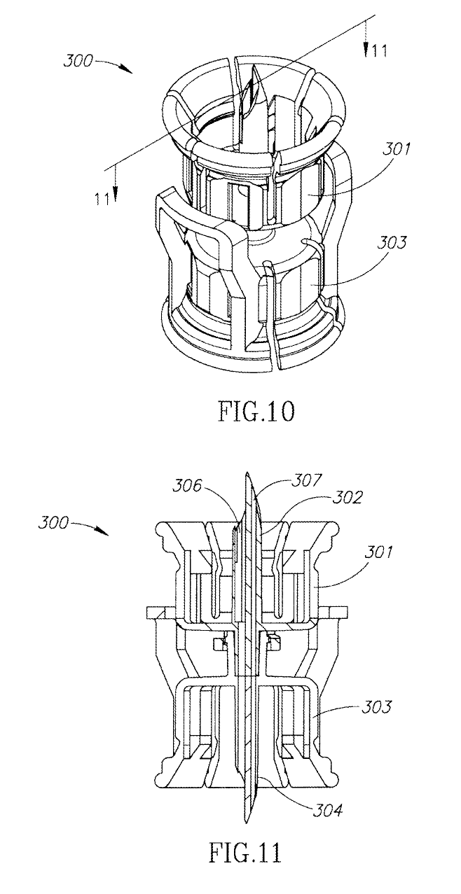

FIGS. 7 to 9 show a dual vial adapter assemblage 200 similar in construction and operation as the hitherto described U.S. Pat. No. 6,558,365 to Zinger et al. Accordingly, the dual vial adapter assemblage 200 includes a liquid vial adapter 201 having an integral single lumen liquid vial stopper puncturing cannula 202 and a quick release drug vial adapter 203 having an integral single lumen drug vial stopper puncturing cannula 204 in flow communication with the liquid vial stopper puncturing cannula 202.

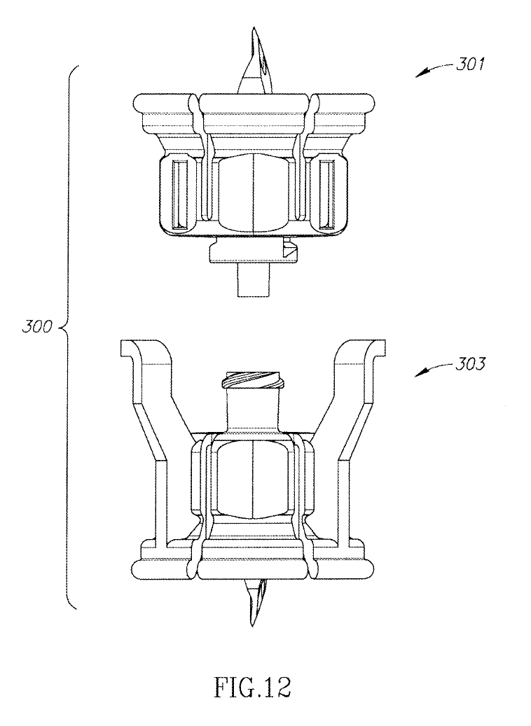

FIGS. 10 to 12 show a dual vial adapter assemblage 300 similar in construction and operation as the hitherto described U.S. Pat. No. 6,558,365 to Zinger et al. The dual vial adapter assemblage 300 includes a liquid vial adapter 301 having an integral dual lumen liquid vial stopper puncturing cannula 302 and a quick release drug vial adapter 303 having an integral dual lumen drug vial stopper puncturing cannula 304 in aligned flow communication with the liquid vial stopper puncturing cannula 302 to form an air transfer lumen 307 and a parallel liquid transfer lumen 306.

While particular embodiments of the present invention are illustrated and described, it would be obvious to those skilled in the art that various other changes and modifications can be made without departing from the spirit and scope of the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A dual vial adapter assemblage for use with a drug vial and a liquid vial, the drug vial having a drug vial bottle and a drug vial stopper sealing the drug vial bottle containing a medicament, the liquid vial having a liquid vial bottle and a liquid vial stopper sealing the liquid vial bottle containing liquid contents for forming a liquid drug from the medicament in the drug vial, the dual vial adapter assemblage comprising:
(a) a drug vial adapter having a longitudinal drug vial adapter centerline and including a transverse drug vial adapter top wall with an upright female connector and an opposite downward depending drug vial adapter skirt with a snap fit flex member pair resiliently flexible at said transverse drug vial adapter top wall and having an inward directed protrusion pair for telescopic snap fit mounting on the drug vial;
(b) a liquid vial adapter having a longitudinal liquid vial adapter centerline co-axial with said longitudinal drug vial adapter centerline on an initial sealed releasable inter-engagement with said drug vial adapter, said liquid vial adapter including a transverse liquid vial adapter top wall, a liquid vial adapter skirt for telescopic mounting on the liquid vial and a liquid vial stopper puncturing cannula for puncturing the liquid vial stopper on said telescopic mounting said liquid vial adapter on the liquid vial; and
(c) a drug vial stopper puncturing cannula for puncturing the drug vial stopper on said telescopic snap fit mounting said drug vial adapter on the drug vial, said drug vial stopper puncturing cannula being in flow communication with said liquid vial stopper puncturing cannula in said initial sealed releasable inter-engagement of said liquid vial adapter and said drug vial adapter,
characterized in that said drug vial adapter is a quick release drug vial adapter further including an upright finger grip extension pair oppositely extending to said snap fit flex member pair for manual inward urging towards one another for selectively pivoting said snap fit flex member pair at said transverse drug vial adapter top wall for outwardly urging their said inward directed protrusion pair away from said longitudinal drug vial adapter centerline for facilitating release of said drug vial adapter from the drug vial thereby exposing the drug vial stopper,
said upright finger grip extension pair facing said liquid vial adapter skirt in said initial sealed releasable inter-engagement of said liquid vial adapter and said drug vial adapter and being sufficiently close to said liquid vial adapter skirt such that said liquid vial adapter skirt prevents said manual inward urging of said upright finger grip extension pair towards one another to release said drug vial adapter from the drug vial.

2. The assemblage according to claim 1 wherein said liquid vial adapter includes a dual ended dual lumen spike having said liquid vial stopper puncturing cannula and said drug vial stopper puncturing cannula.

3. The assemblage according to claim 1 wherein said liquid vial adapter includes an integral liquid vial stopper puncturing cannula and said drug vial adapter includes an integral drug vial stopper puncturing cannula.
